(19) United States
(12) Patent Application Publication
(10) Pub. No.: US 2013/0167809 A1
(43) Pub. Date: Jul. 4, 2013

(54) METHOD AND DEVICE FOR OPERATING A FUEL INJECTION SYSTEM

(71) Applicants: Matthias Siedentopf, Heimsheim (DE); Christian Kuhnert, Vaihingen/Enz (DE); Daniel Heitz, Rutesheim (DE)

(72) Inventors: Matthias Siedentopf, Heimsheim (DE); Christian Kuhnert, Vaihingen/Enz (DE); Daniel Heitz, Rutesheim (DE)

(73) Assignee: ROBERT BOSCH GMBH, Stuttgart (DE)

(21) Appl. No.: 13/809,125

(22) PCT Filed: Jun. 27, 2011
(86) PCT No.: PCT/EP2011/060686

§ 371 Date: Mar. 25, 2013

(30) Foreign Application Priority Data
Jul. 12, 2010 (DE) 10 2010 031 220.7

(51) Int. Cl. F02M 69/04

(52) U.S. Cl. CPC F02M 69/04
USPC 123/478

(57) ABSTRACT

In a method for operating a fuel injection system for an internal combustion engine of a motor vehicle, an output signal of a pressure sensor which characterizes a fuel pressure in a pressure accumulator is evaluated. An undesirably high fuel pressure in the pressure accumulator and/or a fault in the fuel injection system is/are inferred at the time when the output signal assumes a maximally possible value for at least a predefinable monitoring period.

### BACKGROUND OF THE INVENTION

1. Field of the Invention

The present invention relates to a method and a device for operating a fuel injection system, in particular for an internal combustion engine of a motor vehicle, in which an output signal, which characterizes a fuel pressure in a pressure accumulator, of a pressure sensor associated with the pressure accumulator is evaluated.

2. Description of the Related Art

A method and a device of this type are already known from published European patent document EP 1 310 655 B1. The known methods and devices have the disadvantage that a reliable recognition of an undesirably high fuel pressure in the pressure accumulator is only possible with significant delays so that, under certain circumstances, short-term critical pressure rises in the pressure accumulator may not be recognized in time.

### BRIEF SUMMARY OF THE INVENTION

It is thus the object of the present invention to improve a method and a device of the type mentioned at the outset in such a way that a pressure rise may be recognized as quickly as possible.

This object is achieved according to the present invention by a method of the type mentioned at the outset in that an undesirably high fuel pressure in the pressure accumulator and/or a fault in the fuel injection system is/are inferred at the time when the output signal of the pressure sensor assumes a maximally possible value for at least a predefinable monitoring period.

The present invention is based on the fact that when the pressure sensor is within its operating range, it usually outputs an output signal which is proportional to the detected fuel pressure. The pressure sensor acts as a limiter outside this operating range, i.e., it delimits the output signal to a maximally possible value for the output signal as soon as the fuel pressure reaches a predefinable limiting value, e.g., an upper limiting value of the operating range of the pressure sensor. This limiting value is, for example, approximately 200 bar above a nominal working pressure of the fuel system; the nominal working pressure of the fuel system may account for up to approximately 2,000 bar.

As soon as the fuel pressure monitored by the pressure sensor exceeds the limiting value, the output signal of the pressure sensor no longer changes or changes only insignificantly. In other words, in this value range of the fuel pressure, which lies above the limiting value, proportionality no longer exists between the fuel pressure and the output signal of the pressure sensor. The proportionality only exists below the limiting value.

This change in the characteristic of the pressure sensor, which may also be understood as a “kink” in a transmission function (pressure to output signal) or characteristics curve of the pressure sensor, is used according to the present invention to determine almost immediately that the pressure limiting value has been reached. In particular, filter algorithms, which perform low-pass filtering of the output signal, for example, and which thus respond inertially to an increase in the output signal, may be completely dispensed with when using this evaluation strategy. As soon as the delimitation of the output signal has been recognized for the predefinable monitoring period, a fault may be inferred, for example. The monitoring period is preferably selected to be considerably shorter than the time constant of conventional filter algorithms.

In one preferred variant of the present invention, the pressure sensor outputs an electrical output signal, an electrical voltage, for example, which is usually proportional to the detected fuel pressure in the normal working range of the pressure sensor. As soon as the detected fuel pressure reaches or exceeds the predefinable limiting value, the pressure sensor delimits its electrical output voltage, which represents the output signal, to a corresponding voltage limiting value, i.e., a maximally possible output voltage of the pressure sensor. Upon reaching this voltage limiting value, a control unit, which evaluates the output signal of the pressure sensor, may accordingly infer that the fuel pressure limiting value has been reached.

An even more reliable recognition of an undesirably high fuel pressure in the pressure accumulator or of a fault in general is possible according to another variant of the present invention when an undesirably high fuel pressure in the pressure accumulator or the fault is inferred only at the time when a change over time of the output signal has exceeded a predefinable maximum value before the maximally possible value for the output signal has been reached. This means that in this variant of the present invention, a second criterion, namely the evaluation of a gradient of the output signal, is added to the first criterion for the recognition of an overpressure (delimitation of the output signal of the pressure sensor). According to the present invention, the undesirably high fuel pressure is, in addition to the first criterion, inferred only if a predefinable maximum value for the time gradient of the output signal has been exceeded, i.e., if the output signal of the pressure sensor changes particularly strongly over time.

According to another advantageous specific embodiment, at least one countermeasure reducing the pressure in the pressure accumulator may be initiated upon recognition of an undesirably high pressure in the pressure accumulator and/or a fault in the fuel injection system. For example, the countermeasure may include deactivating a supply unit which supplies the pressure accumulator with pressurized fuel, e.g., a fuel high-pressure pump or a metering unit which provides the fuel high-pressure pump with fuel on the input side. Furthermore, the countermeasure may include activating a pressure control valve to allow fuel to exit the pressure accumulator.

The operating method according to the present invention is particularly suited for use in a fuel injection system which is designed as a dual-actuator system and in which the fuel pressure prevailing in the pressure accumulator may thus be influenced with the aid of two actuators (metering unit for the fuel high-pressure pump on the low-pressure side and pressure control valve on the high-pressure side).

According to another advantageous specific embodiment, the output signal may be checked for plausibility by taking into account at least one other operating variable of the fuel injection system. Here, the actuators (metering unit of a high-pressure pump, pressure control valve) may, in particular, be checked for plausibility with the aid of an electrical diagnosis.

### BRIEF DESCRIPTION OF THE DRAWINGS

FIG. 1 shows a schematic block diagram of an internal combustion engine having a fuel injection system operated according to the present invention.

FIG. 2 shows a characteristics curve over time of the operating variables of a fuel injection system.

### DETAILED DESCRIPTION OF THE INVENTION

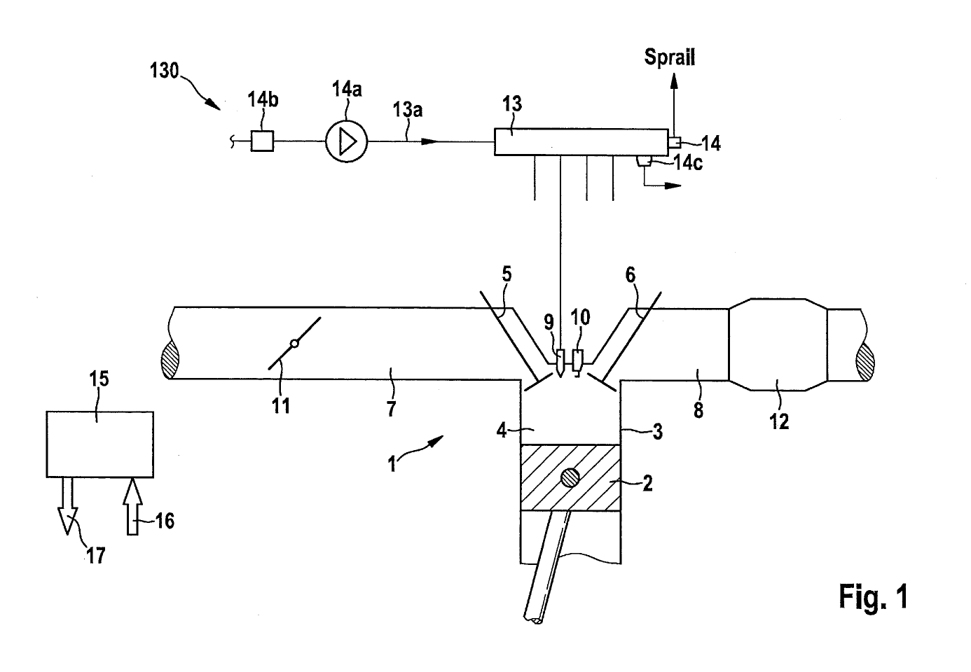

FIG. 1 shows an internal combustion engine 1 of a motor vehicle, in which a piston 2 is movable back and forth in a cylinder 3. Cylinder 3 is provided with a combustion chamber 4 which is delimited by piston 2, an inlet valve 5 and an outlet valve 6, among other things. Inlet valve 5 is coupled to an intake manifold 7, and outlet valve 6 is coupled to an exhaust pipe 8. A fuel system of internal combustion engine 1 is labeled with reference numeral 130.

In the area of inlet valve 5 and outlet valve 6, an injector 9 and a spark plug 10 protrude into combustion chamber 4. Injector 9 may be used to inject fuel into combustion chamber 4. Spark plug 10 may be used to ignite the fuel in combustion chamber 4. Although in the present case an externally ignited internal combustion engine 1 is described, the present invention is also applicable to self-igniting internal combustion engines or their fuel systems.

A rotatable throttle valve 11, via which air may be supplied to intake manifold 7, is accommodated in intake manifold 7. The quantity of air supplied depends on the angular position of throttle valve 11. A catalytic converter 12, which is used to clean the exhaust gases created as a result of the fuel combustion, is accommodated in exhaust pipe 8.

Injector 9 is connected via a pressure line to a fuel accumulator 13, also referred to as a common rail. The injectors of the other cylinders (not illustrated in the present case) of internal combustion engine 1 are connected accordingly to fuel accumulator 13. Fuel accumulator 13 is supplied with fuel via a feed line 13a. For this purpose, a fuel high-pressure pump 14a is provided which is suitable for building up the desirable pressure in fuel accumulator 13. On the input side, fuel high-pressure pump 14a is assigned a metering unit 14b which is designed to control a fuel quantity supplied to fuel high-pressure pump 14a on the suction side.

Furthermore, a pressure sensor 14, which may be used to measure the pressure in fuel accumulator 13, is situated on fuel accumulator 13. This pressure is the pressure which is applied to the fuel and using which the fuel is thus injected via injector 9 into combustion chamber 3 of internal combustion engine 1.

While internal combustion engine 1 is in operation, fuel is conveyed into fuel accumulator 13. This fuel is injected into associated combustion chambers 4 via injectors 9 of individual cylinders 3. With the aid of spark plugs 10, combustions are generated in combustion chambers 3 which prompt pistons 2 to move back and forth. These movements are transferred to a crankshaft (not shown) and apply a torque on the crankshaft.

A control unit 15 is acted upon by input signals 16 which represent the operating variables of internal combustion engine 1 measured with the aid of sensors. For example, control unit 15 is connected to pressure sensor 14, an air mass flow sensor, a lambda sensor, a rotational speed sensor, or the like. Furthermore, control unit 15 is connected to an accelerator sensor which generates a signal indicating the position of an accelerator pedal operatable by a driver and thus the required torque. Control unit 15 generates output signals 17 using which the behavior of internal combustion engine 1 may be influenced via actuators. For example, control unit 15 is connected to injector 9, spark plug 10, and throttle valve 11 and the like, and generates the signals necessary to activate them.

Control unit 15 is, in particular, also designed to evaluate output signal Sprail of pressure sensor 14, which characterizes the fuel pressure in pressure accumulator 13. It is advantageously provided that an undesirably high fuel pressure in pressure accumulator 13 and/or a fault in fuel injection system 130 is/are inferred at the time when output signal Sprail assumes a maximally possible value for at least a predefinable monitoring period.

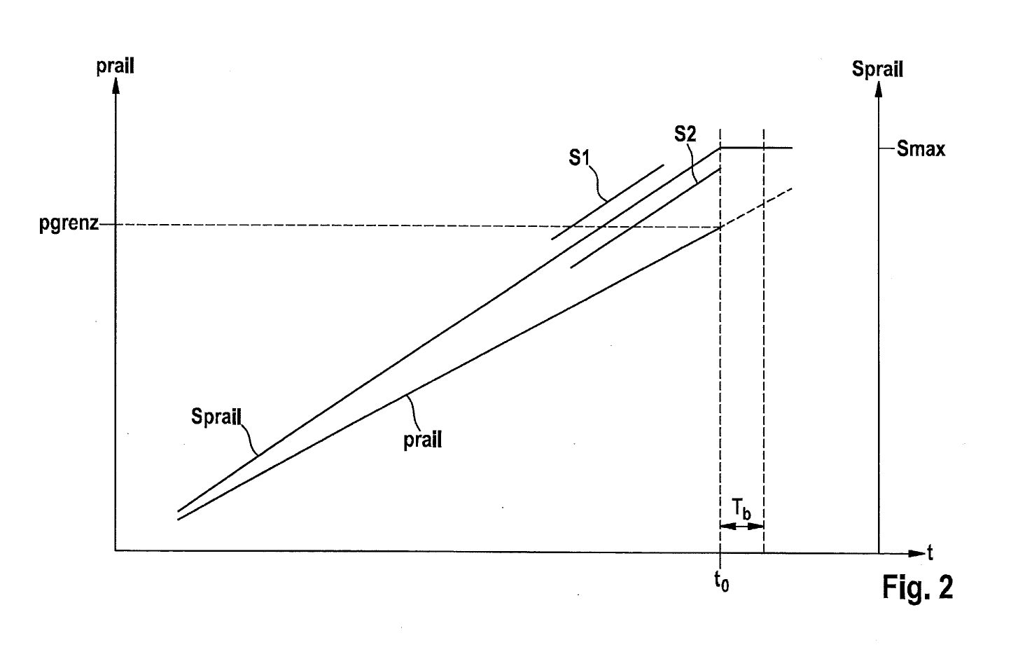

FIG. 2 shows a characteristics curve over time of fuel pressure prail in pressure accumulator 13 (FIG. 1) as well as a corresponding output signal Sprail of pressure sensor 14, which may be an output voltage, for example. Rail pressure prail is indicated on the left-hand ordinate in FIG. 2, while output signal Sprail is indicated on the right-hand ordinate in FIG. 2.

It is apparent from FIG. 2 that fuel pressure prail continuously rises in the illustrated operation scenario as may be the case with a malfunction of a pressure controller or also of metering unit 14b (FIG. 1), for example. At point in time t=t0, fuel pressure prail has reached a predefinable limiting value pgrenz for the proper operation of pressure sensor 14. Up to this limiting value pgrenz, output signal Sprail of pressure sensor 14 is essentially proportional to actual pressure prail. In the case of rail pressures prail above limiting value pgrenz, pressure sensor 14 does, however, no longer output an output signal Sprail proportional to fuel pressure prail, but rather a constant output signal Smax which has a maximally possible value corresponding to pressure limiting value pgrenz. In this respect, pressure sensor 14 or its electronics, which provides output signal Sprail, acts as a limiter.

In the scenario according to FIG. 2, pressure sensor 14 thus outputs starting from point in time t0 only the output signal which is delimited to value Smax and is hence constant, although rail pressure prail continues to rise (cf., dashed part of the pressure curve for t>t0).

This effect is used according to the present invention to determine the occurrence of an undesirably high fuel pressure in pressure accumulator 13 or a fault of fuel injection system 130 associated with it.

According to one particularly preferred specific embodiment, the monitoring of output signal Sprail continues for a predefinable monitoring period Tb starting from point in time t0 of reaching limiting value pgrenz. Unless output signal Sprail drops again below maximum value Smax within this monitoring period Tb, i.e., when output signal Sprail assumes maximally possible value Smax for predefinable monitoring period Tb, it is inferred that fuel pressure prail might continue to rise and thus assumes undesirably high values, or that there is a fault in fuel injection system 130.

According to the present invention, monitoring period Tb may be advantageously selected to be so short that it is considerably shorter than the filter times known from conventional evaluating algorithms which are based on a low-pass filtering of rail pressure prail. This advantageously makes it possible to recognize a fault or an undesirably high fuel pressure already after a very short time Tb, while conventional methods are not able to already deliver a similar evaluation result due to the filtering.

In another advantageous specific embodiment, in addition to recognizing maximally possible value Smax of output signal Sprail, it is provided that the time gradient of output signal Sprail is observed before it reaches maximally possible value Smax for output signal Sprail.

For example, it may be provided that, for recognizing a fault or an undesirably high fuel pressure in pressure accumulator 13 before point in time t0 of reaching maximally possible value Smax, a particularly steep slope of output signal Sprail, i.e., a particularly great time gradient, must be present so that a fault of fuel injection system 130 is recognized. Boundaries S1, S2 indicated by straight line segments in FIG. 2 define as an example a possible range for the time gradient of output signal Sprail. As long as the gradient of output signal Sprail lies within the range defined by boundaries S1, S2, and as long as output signal Sprail subsequently assumes maximally possible value Smax for a predefinable monitoring period Tb, an undesirably high fuel pressure in pressure accumulator 13 or a fault in fuel injection system 130 (FIG. 1) is advantageously inferred.

According to another advantageous specific embodiment, at least one countermeasure reducing fuel pressure prail in pressure accumulator 13 may be initiated upon recognition of an undesirably high pressure in pressure accumulator 13 and/or a fault in fuel injection system 130. For this purpose, a high-pressure pump 14a (FIG. 1) which applies highly pressurized fuel to pressure accumulator 13 may, for example, be deactivated. In conventional common-rail systems in which a fixed mechanical coupling is provided between fuel high-pressure pump 14a and common rail 13, a metering unit 14b, which influences the fuel supply into pressure accumulator 13, may be activated as an alternative to counteract the pressure rise.

Another countermeasure may be to operate a pressure control valve 14c of fuel injection system 130 to allow fuel to exit pressure accumulator 13 in a controlled manner.

In another particularly advantageous specific embodiment of the method according to the present invention, it may be provided, for the purpose of increasing the precision of the evaluation, to check output signal Sprail of pressure sensor 14 for plausibility by taking into account at least one other operating variable of fuel injection system 130, for example, those variables which are obtained by an electrical diagnosis of metering unit 14b or pressure control valve 14c.

The use of the principle according to the present invention advantageously makes it possible to delimit the fuel pressure in pressure accumulator 13 at an early stage. For example, pressure control valve 14c of pressure accumulator 13 may be activated almost immediately, namely after time Tb (FIG. 2), at a fault of metering unit 14b. Alternatively or additionally, an electric fuel pump may also be deactivated which supplies high-pressure pump 14a with fuel via metering unit 14b in a manner known per se. Similarly, at a fault of pressure control valve 14c, the almost immediate closing or deactivating of metering unit 14b of high-pressure pump 14a may be initiated.

Alternatively or additionally, internal combustion engine 1 containing fuel injection system 130 may be deactivated. If necessary, a restart of internal combustion engine 1 may be prevented after a recognized fault of fuel injection system 130.

1-10. (canceled)

11. A method for operating a fuel injection system for an internal combustion engine of a motor vehicle, comprising:
outputting, by a pressure sensor, an output signal which characterizes a fuel pressure in a pressure accumulator;
evaluating the output signal of the pressure sensor to determine the presence of at least one of an undesirably high fuel pressure in the pressure accumulator and a fault in the fuel injection system when the output signal assumes a predefined maximally possible value for at least a predefined monitoring period, wherein the at least one of the undesirably high fuel pressure in the pressure accumulator and a fault in the fuel injection system is inferred only at the time when a change-over time of the output signal has exceeded a predefined maximum change-over time value before the predefined maximally possible value for the output signal has been reached.

12. The method as recited in claim 11, wherein the pressure sensor outputs an electrical output voltage as the output signal.

13. The method as recited in claim 11, wherein the pressure sensor delimits the output signal to the maximally possible value if the fuel pressure exceeds a predefined limiting value.

14. The method as recited in claim 11, wherein at least one countermeasure reducing the pressure in the pressure accumulator is initiated upon recognition of the at least one of the undesirably high pressure in the pressure accumulator and the fault in the fuel injection system.

15. The method as recited in claim 14, wherein the countermeasure includes deactivating a supply unit which supplies the pressure accumulator with pressurized fuel.

16. The method as recited in claim 14, wherein the countermeasure includes activating a pressure control valve to allow fuel to exit the pressure accumulator.

17. The method as recited in claim 14, wherein the output signal is checked for plausibility by taking into account at least one other operating variable of the fuel injection system.

18. A device for operating a fuel injection system for an internal combustion engine of a motor vehicle, comprising:
a control unit configured to (i) evaluate an output signal of a pressure sensor, said output signal characterizing a fuel pressure in a pressure accumulator, and (ii) determine the presence of at least one of an undesirably high fuel pressure in the pressure accumulator and a fault in the fuel injection system when the output signal assumes a predefined maximally possible value for at least a predefined monitoring period, wherein the at least one of the undesirably high fuel pressure in the pressure accumulator and a fault in the fuel injection system is inferred only at the time when a change-over time of the output signal has exceeded a predefined maximum change-over time value before the predefined maximally possible value for the output signal has been reached.

19. The device as recited in claim 18, wherein the control unit is configured to initiate at least one countermeasure reducing the pressure in the pressure accumulator upon recognition of the at least one of the undesirably high pressure in the pressure accumulator and the fault in the fuel injection system.
